(19) United States
(12) Patent Application Publication
(10) Pub. No.: US 2005/0056680 A1
(43) Pub. Date: Mar. 17, 2005

(54) Nail gun

(76) Inventor: Roger Clyde Webb, Tasmania (AU)

Correspondence Address: BIRCH STEWART KOLASCH & BIRCH, PO BOX 747, FALLS CHURCH, VA, 22040-0747, US

(21) Appl. No.: 10/494,478

(22) PCT Filed: Oct. 28, 2002
(86) PCT No.: PCT/AU02/01456

(30) Foreign Application Priority Data
Nov. 2, 2001 (AU) PR 8659
Mar. 14, 2002 (AU) PS 1143

(51) Int. Cl. B25C 1/04

(52) U.S. Cl. 227/9

(57) ABSTRACT

Nail gun (1) comprises barrel (23) and loading mechanism (20) for loading nail from magazine (19) into muzzle (14). Nail (3) is adapted to be propelled by punch (16) via piston shuttle (7) movable by a gas propellant that is initially stored as a liquid in reservoir (2). The liquid is heated to a super critical state in high-pressure chamber (4) by heating element (5) to induce a phase change such that the liquid becomes a highly dense gas. The phase change from liquid to gas provides the energy required to expel nail (3) from muzzle (14), regardless of the ambient temperature. The propellant is preferably CO₂ which is heated to 31.06° C. Pressure selector (9) allows for different pressure settings suitable for softwood, hardwood and masonry nailing applications. Gun (1) produces minimal noise and so reduces workplace noise pollution.

### TECHNICAL FIELD

The present invention relates to a nail gun of the type used in carpentry and construction, and more particularly to such a nail gun that uses a propellant that is initially stored in a liquid phase and undergoes a phase change to a gas to effect propulsion of the nail.

### BACKGROUND

There are three main types of known nail guns. A compressed air gun for soft wood, a butane powered gun for hard wood and a cartridge type gun for concrete, all of which operate in different pressure ranges. A disadvantage of these conventional nail guns is that one gun cannot effectively be used for the various pressure ranges.

The present invention seeks to provide a nail gun that overcomes the disadvantages associated with conventional nail guns as described earlier, by utilising highly dense gas at high pressure as the propellant that is initially stored as a liquid.

### SUMMARY OF THE INVENTION

According to a first aspect the present invention is a nail gun comprising:
an elongate barrel through which a nail is fired;
loading means for introducing said nail into said barrel;
said nail being adapted to be propelled by a piston shuttle movable by a gas propellant, characterised in that said propellant is initially stored as liquid and adapted to be heated by a heating means which induces a phase change such that said propellant becomes a highly dense gas.

Preferably said nail gun comprises at least one chamber for holding said highly dense gas propellant, said chamber being in fluid communication with said barrel via a valve means adapted to release said highly dense gas propellant to fire said nail held in said barrel, and a reservoir located remote from said chamber for storing said propellant in its initial liquid state, and a means for introducing said propellant in its liquid state from said reservoir into said chamber.

Preferably said nail gun further comprises an electronic control unit, which controls the ingress of the propellant in its liquid state from the reservoir to said chamber and controls the heating means used to heat said propellant.

Preferably said nail gun comprises a punch disposed between said piston shuttle and said nail, and said piston shuttle is movable by said highly dense gas to urge against said punch which in turn urges said nail out of said barrel.

Preferably said nail gun is provided with adjustment means for selectively adjusting the pressure of the highly dense gas urging against said piston shuttle.

Preferably as said piston shuttle reaches the end of its travel upon firing, and said highly dense gas has become an exhaust gas, a portion of said exhaust gas is collected and stored in an accumulator operably connected to said loading means.

Preferably said propellant is carbon dioxide.

### BRIEF DESCRIPTION OF THE DRAWING

The invention will now be described with reference to a drawing in which:

FIG. 1 is a schematic elevational view of a nail gun according to an embodiment of the present invention, as a nail is being fired from the nail gun.

### MODE OF CARRYING OUT INVENTION

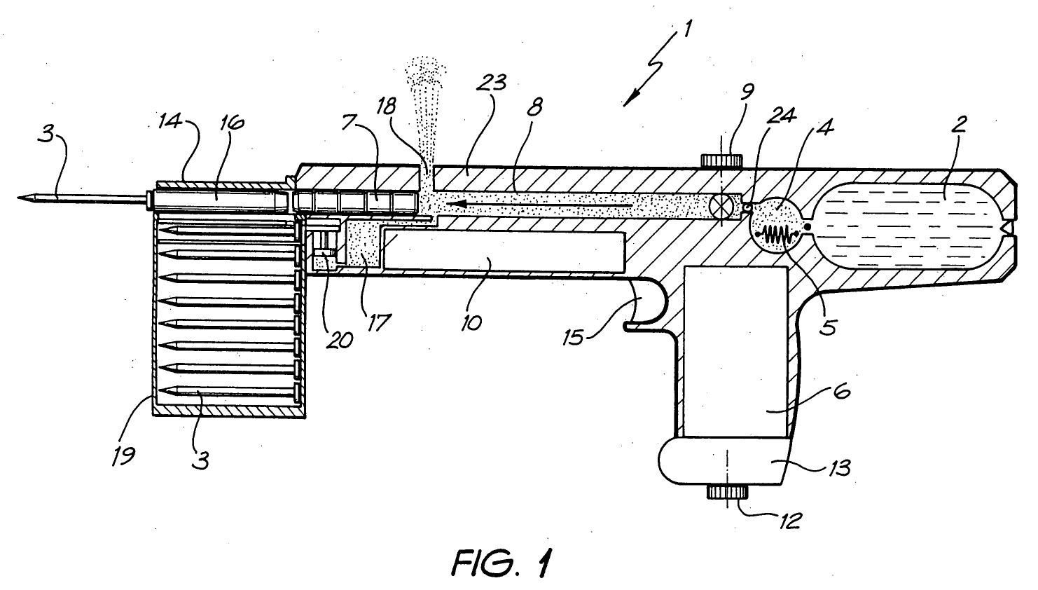

FIG. 1 depicts a nail gun 1 in an embodiment of the present invention. Nail gun 1 is a hand held tool for use in carpentry and construction applications.

Nail gun 1 comprises a 250 cc reservoir 2 of liquid carbon dioxide (CO₂) relying on a phase change to a “super critical fluid” or “highly dense gas” as the explosive energy to expel or fire the nails 3. Nail gun 1 comprises a high-pressure chamber 4, in which liquid CO₂ is induced to change its phase to a highly dense gas. The high-pressure chamber 4 is in fluid communication with barrel 23 via a gas lock-off valve 24. The heating of the CO₂ is achieved by a heating element 5 powered by battery pack 6 similar in size and shape to a conventional cordless drill battery pack. In such an embodiment a piston shuttle 7 located in the bore 8 mechanically transfers the explosive energy of the CO₂ to the nail 3 being fired via punch 16. Nail gun 1 is provided with pressure adjustment means 9, at three different settings say between about 35 bar to 1350 bar, to allow for various nailing applications such as softwood (low pressure), hardwood (medium pressure) and masonry (high pressure). The pressure adjustment means 9 is operably connected to an electronic control unit ECU) 10 that controls and adjusts the supply and pressure of the CO₂ propellant being delivered to chamber 4 and the heating thereof.

When CO₂ is heated to 31.06° C., it changes to a “super critical state” which is a “super critical fluid” or “highly dense gas” at high pressure. In this embodiment the critical state of CO₂ as it changes phase from liquid to a gas, provides the explosive energy required to expel nail 3 from nail gun 1, regardless of the ambient temperature.

The following table depicts the temperature/pressure relationship of Liquid/gas CO₂.

| Temperature (° C.) | Pressure (bar) | |
|---|---|---|
| 21 | 54 | |
| 31 | 74 | Critical point |
| 100 | 250 | |
| 500 | 1250 | |
| 1000 | 2500 | |

The suitability of CO₂ as a preferred propellant can be appreciated by the following:
1 gram of liquid CO₂ will liberate to 500 cc of gas at 25° C.
1 gram of CO₂=0.759 cc at 25° C.
1 cc of liquid CO₂ will liberate to 660 cc at 25° C.

The main advantage of nail gun 1 is that it can replace all three earlier mentioned prior art guns, by its adjustable pressure arrangement and is lighter and easier to handle than the convention nail guns. To operate it for different applications, it requires adjustment of a selector for the desired pressure and matching the appropriate nails for the intended application.

The 250 cc internal gas reservoir 2 would be sufficient to provide 1500 low-pressure nail firings, or 1000 medium pressure nail firings, or 500 high-pressure nail firings.

Audibly the discharge sound is very low thereby assisting to reduce work place noise pollution.

The advantage of nail gun 1 is that the propellant, liquid CO₂ is readily available at gas outlets and is easy to manage. To recharge the onboard reservoir 2 the operator attaches the gun to a small manageable liquid CO₂ cylinder via a high-pressure hose. The gas reservoir 2 built into the gun 1 fills to approximately 250 cc of liquid CO₂.

A magazine of nails, for example suitable for a softwood application, is attached to the gun. The low-pressure setting is then selected. Nail gun 1 is then armed by a switch 12 on the base of the pistol grip 13. The ECU 10 then releases a small quantity of liquid CO₂ gas into the chamber 4. The temperature and pressure is monitored by the ECU 10.

The muzzle 14 of nail gun 1 is pressed against the material to be fastened. A pressure sensor (not shown) in muzzle 14 alerts ECU 10 that nail gun 1 is safe to be discharged. The operator pulls the activator trigger 15. After a one second delay the ECU 10 operably controls heating element 5 to heat the CO₂ in chamber 4, thereby inducing a phase change to a “highly dense gas” and causing its pressure to increase. The “highly dense gas” is then released to barrel 23 via valve 24, thereby propelling piston shuttle 7. The piston shuttle 7 strikes the punch 16 and drives the nail 3 through the work material. The punch 16 whilst adapted to strike nail 3, is restrained such that it cannot exit muzzle 14. As the punch 16 and piston shuttle 7 reach the end of their travel, a primary exhaust port is uncovered to collect and store some high pressure exhaust gas in exhaust accumulator 17, and then the main exhaust port 18 releases the spent gas. As soon as the exhaust gas is expelled, the piston shuttle 7 and punch 16 are returned to their cycle start position by a spring mechanism (not shown). A secondary exhaust port (not shown) is incorporated in valve 24 and is operably activated by trigger 15 to exhaust gas from bore 8. This allows piston shuttle 7 to return fully to the cycle start position. When pressure is relieved from muzzle 14 and the activation trigger 15 released, the stored exhaust gas within accumulator 17 is utilized to reload the gun with a fresh nail 3 from the magazine 19 via a pneumatic mechanism 20. This process can be repeated in approximately a two second cycle.

A small diameter cylinder/bore arrangement is utilized in this design, as much higher pressures can be achieved, thus reducing overall nail gun size and weight.

Preferably the high-pressure chamber 4 is made of metal, however the body of the gun, including the barrel may be made of metal, plastic or a composite material.

In another not shown embodiment the battery 6 may be required by some other external power source.

In another not shown embodiment the CO₂ may initially be stored in a removable reservoir in the form of a canister (not shown) rather than the reservoir 2 shown in the above described embodiment. Such a canister may be either refillable or disposable.

In another not shown embodiment the reservoir 2 or canister for storing CO₂ may be greater or smaller in volume than 250 cc as mentioned for the above described embodiment.

It should be understood that whilst CO₂ has been selected as the preferable propellant due to its properties and commercial availability, however, other liquid/gaseous propellants could be used in alternative embodiments.

The term “comprising” as used herein is used in the inclusive sense of “including” or “having” and not in the exclusive sense of “consisting only of”.

1. A nail gun comprising:
an elongate barrel through which a nail is fired;
loading means for introducing said nail into said barrel;
said nail being adapted to be propelled by a piston shuttle movable by a gas propellant, characterised in that said propellant is initially stored as liquid and adapted to be heated by a heating means which induces a phase change such that said propellant becomes a highly dense gas.

2. A nail gun as claimed in claim 1, wherein said nail gun comprises at least one chamber for holding said highly dense gas propellant, said chamber being in fluid communication with said barrel via a valve means adapted to release said highly dense gas propellant to fire said nail held in said barrel, and a reservoir located remote from said chamber for storing said propellant in its initial liquid state, and a means for introducing said propellant in its liquid state from said reservoir into said chamber.

3. A nail gun as claimed in claim 2, wherein said nail gun further comprises an electronic control unit which controls the ingress of the propellant in its liquid state from the reservoir to said chamber and controls the heating means used to heat said propellant.

4. A nail gun as claimed in any one of claims 1-3, wherein said nail gun comprises a punch disposed between said piston shuttle and said nail, and said piston shuttle is movable by said highly dense gas to urge against said punch which in turn urges said nail out of said barrel.

5. A nail gun as claimed in claim 1, wherein said nail gun is provided with adjustment means for selectively adjusting the pressure of the highly dense gas urging against said piston shuttle.

6. A nail gun as claimed in claim 1, wherein as said piston shuttle reaches the end of its travel upon firing, and said highly dense gas has become an exhaust gas, a portion of said exhaust gas is collected and stored in an accumulator operably connected to said loading means.

7. A nail gun as claimed in claim 1 wherein said propellant is carbon dioxide.
